(19) United States
(12) Patent Application Publication
(10) Pub. No.: US 2005/0078863 A1
(43) Pub. Date: Apr. 14, 2005

(54) Radiation image photographic system and radiation image detecting-processing apparatus

(75) Inventor: Tsuyoshi Ito, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 10/958,585

(22) Filed: Oct. 6, 2004

(30) Foreign Application Priority Data
Oct. 10, 2003 (JP) JP2003-353005

(51) Int. Cl. G06K 9/00; G06K 9/40; G01N 23/04

(52) U.S. Cl. 382/132; 382/254; 378/62

(57) ABSTRACT

A radiation image detecting processing apparatus for outputting an output signal to an output device including a radiation image detecting device for receiving a radiation image on plural detecting elements arranged in a two dimensional layout, generating and outputting an image signal based on the radiation image, and a first conversion device for converting an image signal outputted from the radiation image detecting device into an output signal being a value linear to a visual sense which is independent from the output device.

### BACKGROUND

1. Field of the Invention

The present invention relates to a radiation image photographic system and a radiation image detecting-processing apparatus capable of obtaining radiation images suitable for diagnostics, etc.

2. Description of Related Art

Known is an image inputting apparatus for inputting image information of radiation images formed by the radiation beams passed through the photographic object, which is emitted from a radiation beam generating apparatus to a photographic object for disease diagnostics. There are two types of apparatuses in these image inputting apparatuses. The first type of the image inputting apparatus is a CR type which is a system for focusing stimulation rays generated by scanning laser beams onto a stimulated phosphor plate storing radiation images thereon and converting them to electric signals in a photo-multiplier (hereinafter referred to as “PMT”). The second type of image input apparatus is a FPD type which is a system comprises of an X-ray flat panel detector reforming X-ray energy being irradiated thereto after being transmitted through a subject as an X-ray transmission-type images. And the size of the flat plane of the X-ray panel detector can fully covers the portion of a human body needed for image diagnostics.

A radiation image flat panel detector and a ration image panel are described in Japanese Patent Open to Pubic Inspection, No. H11-237478. In recent years, an X-ray image apparatus which obtains X-ray images (latent images) as image signals by guiding X-rays onto a two-dimensional X-ray image panel instead of the use of photosensitive films, has been developed. It is known that there are an indirect X-ray image apparatus for converting the optical signal converted from X-ray images to electric signals and a direct X-ray image apparatus for directly converting X-ray images to electric signals.

FIG. 1 shows the configuration of an X-ray imaging panel used for the direct X-ray imaging apparatus. The X-ray apparatus shown in FIG. 1 has vertical scanner 30, horizontal scanner 32 and imaging panel 12 in which gate line 14 and signal line 16 are arranged in a matrix shape. Each cell of the matrix corresponds to a pixel which functions as conversion cell 20.

Conversion cell 20 comprises of electric chare layer 22 for generating electric chares according to the strength of X-rays, capacitor 24 for accumulating generated electric chares and switching element 26 for guiding electric signals (image signals) to signal line 16. Thin film transistors (TFT) is used as switching element 26.

According to FIG. 1, electric chare layer 22 occupies about 50% of conversion cell 20. In reality, as shown in FIG. 2, electric charge layer 22 is provided upper side of conversion cell 20 (a surface side on which X-ray is irradiated) and condenser 24 and switching element 26 are arranged in the lower side of electric chare layer 22.

A predetermined high voltage (approximately 5000 volts) is applied to X-ray imaging panel 12 from power supply 28. Generated electric chares (electrons and positive holes) are separated into electrons and positive holes and are accumulated in condenser 24.

When a gate signal for vertical scanning from vertical scanner 30 is applied to a corresponding gate line 14, switching transistors connected to gate line 14 are turned on. Electric chares accumulated in condenser 24 connected to switching transistor 26 which is turned on is guided to horizontal scanner 32 through signal line 16.

In horizontal scanner 32, one line of X-ray image signal is formed by sequentially and horizontally scanning image signals on every conversion cell 22. Then one line of X-ray image signal is guided to signal processing circuit 34 following to horizontal scanner 32. A horizontal scanning may be conducted block by block into which signal lines are divided like a parallel signal processing. In this case the reading time of X-ray image signal can be shortened.

In signal processing circuit 34, the X-ray image signals are converted to digital signals and outputted as density values being the logarithmic values of X-ray image signals.

Further, in regard to FPD, for example, Japanese Patent Publication Open to Public Inspection No. H11-316844 disclosed a density conversion method for a display. Japanese Patent Publication Open to public, No. 2002-30046 disclosed a method for conducting a gradation correction of a logarithmic density value or for reducing noise signals.

In these image data, when dealing with medical image information, traditionally medical images formed on a medium such as film, etc. placed on a viewing box are observed by using transmitted beams through the viewing box. As described in Japanese Patent Publication Open to Public No. 2003-150953, in new observation methods which displays medical images on a monitor such as CRT, etc., there are cases that interpreters of medical images such as medical doctors feel sense of incongruity. One of the causes for occurring problems is that there are differences between the gradation characteristic of images formed on a medium and that of images displayed on monitor. On the other hand, in order to fit the gradation of the images to the human visual characteristic, DICOM (Digital Imaging and Communication in Medicine) has set a predetermined function (a formula) for converting of the luminosity of images when displaying the images on a monitor and described the method to realize it.

Patent reference 1: Japanese Patent Publication Open to Public Inspection, No. H11-237478

Patent reference 2: Japanese Patent Publication Open to Public Inspection, No. H11-316844

Patent reference 3: Japanese Patent Publication Open to Public Inspection, No. 2002-30046

Patent reference 4: Japanese Patent Publication Open to Public Inspection, No. 2003-150953

In FPD, as shown in FIG. 1, since it is possible to conduct A/D conversion of each output signal of every switching element when obtaining digital signals, the output signal becomes linear value, which is in proportion to the quantity of radiation. However, in reality, in other radiation image input apparatus, for example, CR as an image input apparatus for reading stimulated rays by irradiating laser beams onto a plate using stimulated phosphor, a logarithmic conversion circuit is provided after a PMT (Photo Multiplier) to transport signals being in proportion to a logarithmic value of radiation as a density value “D” (Density) to a host computer or a imager. In the case of FPD, the same configuration is used to output the logarithmic value of an obtained linear value so that a density value can be used as a signal.

However, since the signal of FPD at a digitizing stage is a linear value (a luminous value), in order to convert the linear value to a density value “D”, several conversion processes are necessary. In addition to a signal process such as a gradation process, due to output signal conversions to a density value corresponding to the output modality, when conducting the image process to match the output signal to an output signal modality, errors occur at the multiple stage processes. Consequently, there are some possibilities that the accuracy of the output signals becomes worse; a signal processing time is prolonged; and excessive devices are necessary. Consequently, as a whole, there are some possibilities that excessive devices are needed since plural calculation processes or a LUT (Look Up Table) are necessary.

### SUMMARY

An object of the invention is to solve the problems described above and following is embodiment of the invention.

### EMBODIMENT 1

In accordance with anther aspect of the present invention provided is a radiation image detecting processing apparatus for outputting an output signal to an output device including a radiation image detecting device for receiving a radiation image on plural detecting elements arranged in a two dimensional layout, generating and outputting an image signal based on the radiation image, and a first conversion device for converting an image signal outputted from the radiation image detecting device into an output signal being a value linear to a visual sense which is independent from the output device.

### EMBODIMENT 2

In accordance with one aspect of the present invention provided is a radiation image system including a personal computer, a printing device, a data storage device or a display device communicated with the radiation image detecting processing apparatus of EMODIMENT 1.

### EMBODIMENT 3

In accordance with another aspect of the present invention, provided is a radiation image detecting processing apparatus for outputting an output signal to an output device including a radiation image detecting device for receiving a radiation image on plural detecting elements arranged in a two dimensional layout, generating and outputting an image signal based on the radiation image, and an image processing device for processing an image signal outputted from the radiation image detecting device, wherein the image processing device includes a second conversion device for converting an image signal, which is in proportion to a quantity of radiation irradiated to the radiation image detecting device into an output signal being linear to a visual sense which is independent from the output device.

### EMBODIMENT 4

In accordance with another aspect of the present invention provided is a radiation image system including a personal computer, a printing device, a data storage device or a display device communicated with the radiation image detecting processing apparatus of EMBODIMENT 3.

### EMBODIMENT 5

In accordance with another aspect of the present invention, provided is the radiation image detecting processing apparatus of EMBODIMENT 1, wherein the first conversion device includes a first conversion section for setting a luminance difference corresponding to a density difference recognized by an average human being observer by using a grayscale standard display function curve as the value being linear to a visual sense.

### EMBODIMENT 6

In accordance with another aspect of the present invention provided is a radiation image system including a personal computer, a printing device, a data storage device or a display device communicated with the radiation image detecting processing apparatus of EMBODIMENT 5.

### EMBODIMENT 7

In accordance with another aspect of the present invention, provided is the radiation image detecting processing apparatus of EMBODIMENT 3, further including a normalizing processing device for converting the image signal to a normalized image signal of being in proportion to a quantity of radiation irradiated to the radiation image detecting device or a logarithmic value of a quantity of radiation which includes a predetermined signal value, and a processing device for setting an luminance difference of the normalized image signal from the normalizing processing device or at least an image signal to which a gradation process for converting gradation is applied, which corresponding to a density difference of which an average human can recognizes, wherein either the first conversion device or the first conversion device including the first conversion section and the second conversion device are arbitrarily combined so that deterioration of accuracy of image data from the radiation image detecting device and/or process errors caused by a calculation are decreased.

### EMBODIMENT 8

In accordance with another aspect of the present invention provided is a radiation image system including a personal computer, a printing device, a data storage device or a display device communicated with the radiation image detecting processing apparatus of EMBOCIMENT 7.

### EMBODIMENT 9

In accordance with another aspect of the present invention, provided is the radiation image detecting processing apparatus of EMBODIMENT 1, wherein the first conversion device including, a second conversion section for setting a luminance difference as a P-value corresponding to a density difference recognized by an average human being by using a grayscale standard display function curve as a value being linear to a visual sense.

### EMBODIMENT 10

In accordance with another aspect of the present invention provided is a radiation image system including a personal computer, a printing device, a data storage device or a display device communicated with the radiation image detecting processing apparatus of EMBODIMENT 9.

### EMBODIMENT 11

In accordance with another aspect of the present invention, provided is the radiation image detecting processing apparatus of EMBODIMENT 1, wherein the first converting device includes a third conversion section for converting radiation image information to output signal being a luminous value of which average observer can recognize under a certain observation condition.

### EMBODIMENT 12

In accordance with another aspect of the present invention provided is a radiation image system including a personal computer, a printing device, a data storage device or a display device communicated with the radiation image detecting processing apparatus of EMBODIMENT 11.

### EMBODIMENT 13

In accordance with another aspect of the present invention, provided is the radiation image detecting processing apparatus of EMBODIMENT 1, wherein the radiation image detecting device outputs a 14 bit or 16 bit image signal.

### EMBODIMENT 14

In accordance with another aspect of the present invention provided is a radiation image system including a personal computer, a printing device, a data storage device or a display device communicated with the radiation image detecting processing apparatus of EMBODIMENT 13.

### EMBODIMENT 15

In accordance with another aspect of the present invention, provided is the radiation image detecting processing apparatus of EMBODIMENT 1, wherein the radiation image detecting device outputs a 14 bit or 16 bit image signal, and the radiation image detecting device utilizes a grayscale standard display function curve for setting a luminance difference corresponding to a density difference of which an average human being observer can recognize to convert the radiation image information.

### EMBODIMENT 16

In accordance with another aspect of the present invention provided is a radiation image system including a personal computer, a printing device, a data storage device or a display device communicated with the radiation image detecting processing apparatus of EMBODIMENT 15.

The present invention has following advantages by a configuration described above.

According to the present invention, it is possible to improve data accuracy since obtained linear values can be directly converted to output values being independent from output devices without converting to density values, since the present invention can removes rounding errors caused by plural calculating processes and decreased-accuracy from digital data which are liner values outputted from radiation detecting elements, and also remove excessive resources to perform plural processes. It is unnecessary to have excessive devices as a total system, since it is not necessary to perform plural calculating processes and/or to have a LUT.

### BRIEF DESCRIPTION OF DRAWINGS

FIG. 1 shows an X-ray imaging panel used for an X-ray photographic apparatus.

FIG. 2 shows a cross-section on an X-ray imaging panel.

FIG. 3 shows a grayscale standard function curve.

FIG. 4 shows a grayscale standard function curve.

FIG. 5 shows a gradation characteristic.

FIG. 6 shows the internal configuration of signal processing circuit 34 shown in FIG. 1.

FIG. 7 shows the functions of correction processor 342 shown in FIG. 6.

FIG. 8 shows the functions of P-value processor 343 shown in FIG. 6.

FIG. 9 shows a circuit configuration for conducting a P-vale conversion without having a software method controlled by CPU.

### DETAILED DESCRIPTION OF PREFERED EMBODIMENT

The examples of the present invention for a radiation image photographic system and a radiation image detecting-processing apparatus will be described below. The present invention is not limited to the examples. The examples of the present invention show the most preferable examples and the scope of present invention is not limited to the examples.

The present invention is characterized that in FPD, the digital data of linear value outputted from radiation detecting elements is directly converted to a value being independent from output devices while avoiding to generate rounding errors associated with plural calculation processes and saving excessive resources and times to conduct plural processes without converting an obtained linear value to density a value. “The output devices” means for example, not only an imager used for a film output or a monitor display but also a server for distributing images through network, a server for data storages and storage devices for storing image data. The linear value outputted from the radiation detecting element is converted to a final output form via one direct calculation or a conversion table.

As the final out form, P-value is defined as a luminous difference value of which a human being can recognize using GSDF (Grayscale Standard Display Function) curve defined in the standard of DICOM (Digital Imaging and Communication in Medicine), which is independent from a signal form of the output device. How to obtain P-value will be described below.

A basic concept of P-value will be described by using a following model.

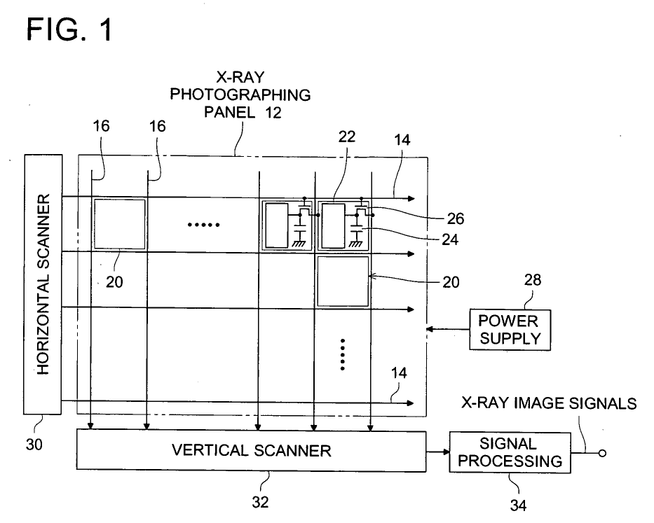

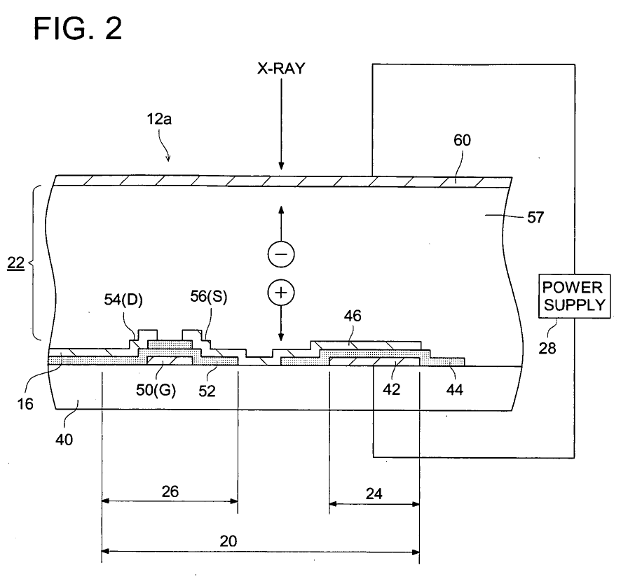

As a radiation image detecting device, there is a FPD as shown in FIG. 1. In the internal configuration of FPD shown in FIG. 2, gate electrode 50 or gate “G” is formed on glass substrate 40. Insulation layer 52 is formed over gate 50. TFT 26 functioning as a switching element is formed adjacent condenser 24. Darin “D” or drain electrode 54 and source “S” or source electrode 46 are uniformly formed. Drain electrode 54 is used not only for an electrode but also signal line 16.

Optical-conductive layer 57 functioning as electric chare generating layer 22 is formed over condenser 24 and TFT 26 formed on substrate 40 so that the thickness of optical-conductive layer 57 is reached to a predetermined value. Optical-conductive layer 57 is made of amorphous Selenium (a-Se), etc. and generally, an evaporation process forms optical-conductive layer 57. Over optical-conductive layer 57, common electrode 60 is formed and conversion cell 20 is formed.

As described above, high voltage from power 28 is applied between electrodes 42 and 60. While the high voltage is applied, X-ray being transmitted through a subject such as a human body is irradiated toward panel 12 from the front side of panel 12 as shown in FIG. 2. Electric charges corresponding to the strength of X-rays are generated by X-rays incident into optical conductive layer 57. The high voltage (electric field) applied between electrodes 42 and 60 separates the electric charges. An electron having a minus charge and a hole having a plus charge are drawn to electrode 60 and electrodes 46 and 56 respectively. Condenser 24 captures electric charges drawn to electrodes 46 and 56 and electric charges corresponding to X-ray energy are stored between electrodes 42 and 46 of condenser 24. Electric charges stored in condenser 24 are guided to horizontal scanner 32 via signal line 16 connected to drain electrode 54 when TFT 26 is turned on.

The output of each element (condenser), which is a liner value, is converted to digital data via an A/D converter. For example, it is assumed that a 14 bit digital data of a linear value is obtained. The data is defined as “X”.

In order to obtain a standard visual characteristic, a density value being an output format used for CR and having long experiences is calculated as a value of luminance differences of which a visual sense can recognize based on an output format for the film output of an imager. When converting a linear value to a density value, a following formula is used.
DV=log(X+α)+β (1)
Where: α and β represent constant values associated with an element.

DV value (assumed 14 bit value) is obtained as a relative density. In the relative density DV, the minimum value of the DV value corresponds to the minimum density of a film and the maximum value of DV corresponds to the maximum density of the film. The both DV values lineally correspond to the minimum and maximum density values of the film.

It is better to apply a gradation process in order to obtain radiation images having appropriate gradation and contrast, since obtained DV value is a relative density value. In a gradation process, a gradation conversion curve shown in FIG. 5 is used for converting image data DV to output image data DVₒᵤₜ so that reference values S1 and S2 are converted to levels S1′ and S2′. Levels S1′ and S2′ correspond to a predetermined luminosity or a photographic density. It is preferable that not only a gradation conversion curve but also a derived function of the gradation conversion curve is a continuous function across the entire signal region. Also it is preferable that a differential coefficient of the derived function is constant across the entire signal region. Since, levels S1′ and S2′, and a preferable gradation curve change according to a photographic region, a photographic posture, a photographic condition and a photographic method, the gradation curve may be changed in an every photographing scene.

A density “D” can be obtained from a relative density DV (or it may be DVₒᵤₜ after a gradation process) by a following formula.
D=Dmin_{—}def+DV/16383×(Dmax_{—}def−Dmin_{—}def) (2)
Where: Dmax_def (normally it is 3.0 [D]) is the maximum density of a standard film; Dmin_def (normally it is 0.2 [D]) is the minimum density of a standard film; and 16383 is a maximum number of 14 bit.

Here, luminosity (cd/mm²) is obtained when a film is watched on a viewing box by using a following formula.
Lf=La_{—}def+L0_{—}def*10^{(-D)} (3)
Lf_min=La_{—}def×10^{(-Dmax}^{_{—}}^{def)} (4)
Lf_max=La_{—}def×10^{(-Dmin}^{_{—}}^{def)} (5)
Where: Lf is film luminosity at an arbitrary density D. Lf_min is a minimum luminance value. L_max is a maximum luminance value. L0_def is the luminosity of a viewing box, (normally, it is 2000 [cd/mm²]; La_def is the reflection luminosity of a standard film, where a black portion with no transmitted light, (normally, 10 [cd/mm²].

According to the luminosity above, JNDindex (Just-Noticeable Difference) can be obtained. In a discrimination region, JND means a film density difference on a viewing box, as the smallest target of which an average a human being can recognize under a given observation condition.

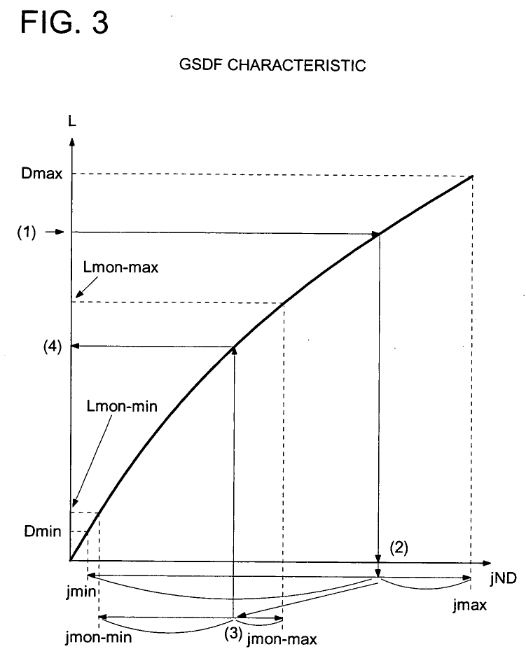

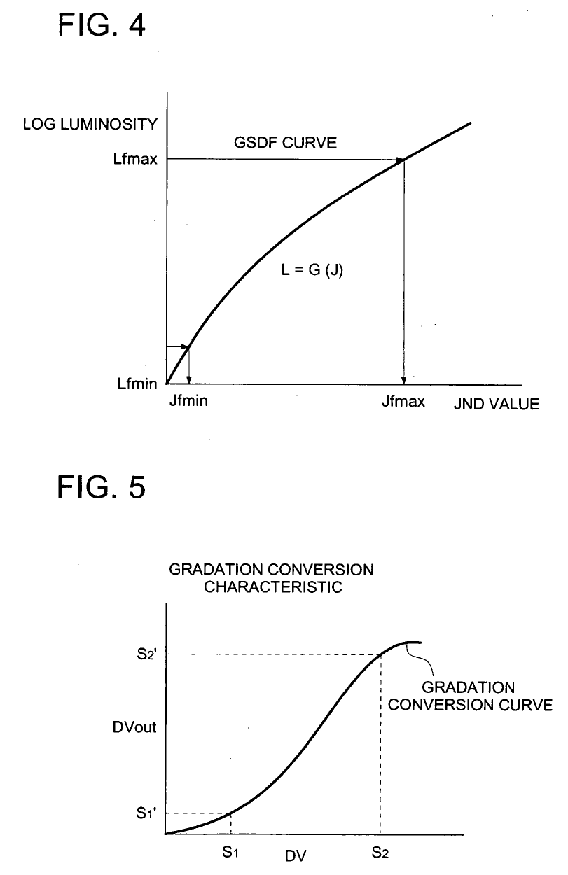

One step of JND corresponds to a minimum width of luminosity being identified by a human being. In a dark portion, it is easy to notice a small difference of luminosity, however difficult to notice unless a luminance difference reaches a certain level in a bright portion. The relationship between luminosity and JND is defined in DICOM standard which are Grayscale standard display function curve and GSDF curve shown in FIGS. 3 and 4 respectively.

The grayscale standard display function is given by a following formula as j( ).
j(L)=A+Blog(L)+C(log(L))2+D(log(L)3+E(log(L))4+F(log(L))5+G(log(L))6+H(log(L))7+I(log(L))8 (6)
Where: A=71.498068, B=94.593053, C=41.912053, D=9.8247004, E=0.28175407, E=0.28175407, F=−1.1878455, G=−0.18014349, H=−0.14710899, I=−0.017046845 and log is a common logarithm whose base is 10.

JNDindex can be obtained as follows by using j( ) and luminosity Lf.
JNDf_{—}def=j(Lf)
(7): JNDindex at arbitrary luminosity Lf.
   JNDf_{—}def_min=j(Lf_min)
(8): The minimum JND of a film.
   JNDf_{—}def_max=j(Lf_max)
(9): The maximum JND of a film.

P value is given by a following formula.
P=(JNDf_{—}def−JNDf_{—}def_min)×(JNDf_max−JNDf_{—}def_min)×16383 (10)

Signals outputted from FPD are converted to P values via signal processor 34 shown in FIG. 1 and distributed to various output devices. The present invention relates to a radiation image detection processing apparatus having a signal processor directly converting obtained linear digital signals to P-values by making conversion formulas or a conversion table based on formulas from (1) to (10).

How to directly convert linear digital singles from FPD to P-values will be described below. Following is a description of how to directly convert linear signals outputted from FPD to digital data via 14 bit A/D converter in FDP detecting device shown in FIG. 1. Firstly, substitute formulas (7)-(9) for formula (10).
P=(j(Lf)−j(Lf_min))×(j(Lf_max)−j(Lf_min))×16383 (11)

Substitute formulas (1)-(5) for formula (11), then formula (12) will be obtained.
P=[j{La_{—}def+L0_{—}def'10^{(-Dn}^{_{—}}^{def)+log(X+α)}+β/16383×(Dmax_{—}def−Dmin_{—}def)}]−j{La_{—}def+L0_{—}def×10^{(-Dmax}^{_{—}}^{def)}}][j{La_{—}def+L0_{—}def×10^{(-Dmin}^{_{—}}^{def)}}×j{La_{—}def+L0_{—}def×10^{(-Dmax}^{_{—}}^{def)}}]×16383 (12)
J(L)=A+Blog(L)+C(log(L))²+D(log(L))³+E(log(L))⁴+F(log(L))⁵+G(log(L))⁶+H(log(L))⁷+I(log(L))⁸ (6)
Where: La_def, L0_def, Dmax_def, Dmin_def, α and β are constant values.

Here, since grayscale standard display function j( ) is given by formula (6), P-value can be directly obtained from a linear 14 bit digital signal “X”.

Form the viewpoint of a speedy process, in reality it is preferable to refer a LUT (Look Up Table) including calculated P-values when obtaining a P-value even though the P-value can be obtained by substituting the linear value of image signal for which an A/D conversion has been applied for formulas (6) and (12).

Since, the linear signal value used in this embodiment is set at 14 bit, one of a value from 0 to 16383 is used in formula (12), a P-value is obtained. It becomes possible to install a LUT converting linear signals to P-values in signal processor 34 shown in FIG. 1 and outputting P-values. By preparing a conversion table in advance, it become possible to calculate necessarily and sufficiently accurate values for the conversion table in advance.

### EXAMPLE 1 OF SIGNAL PROCESSING

A P-value direct output system using a conversion table will be described below.

The number of input signal line to signal processor 34 may be parallel input lines, however in reality, a single signal line input is popular from cost saving point of view by rearranging parallel signals to a time series signal via a multiplexer, etc.

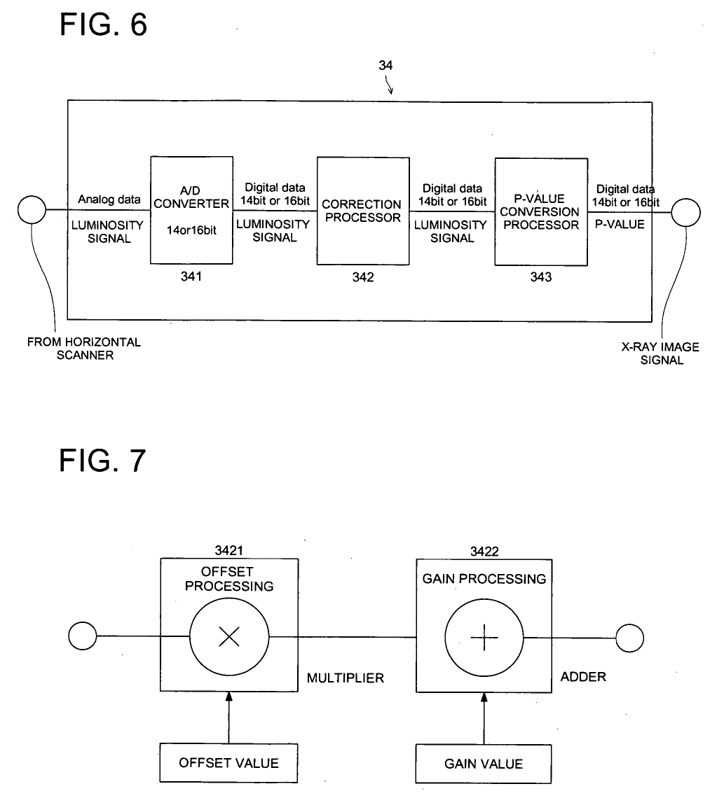

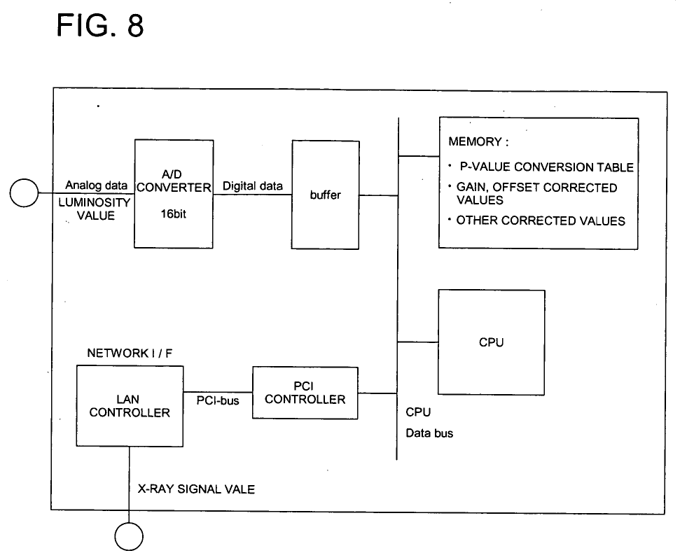

The concrete functions of signal processor 34 will be described according to the configuration shown in FIG. 6. A circuit diagram is shown in FIGS. 7 and 8.

FIG. 6 shows the circuit configuration of signal processor 34. A/D converter 341 converts analog data to 14 bit or 16 bit digital data. Correction processor 342 calculates for correcting unevenness or sensitivity between pixels (or cells) of FPD and for adjusting gain and offset as a detector. In regard to gain and offset, they will be described later. P-value conversion processor 343 converts a signal value passed through correction processor 342 to a P-value based on a calculation formulas (6) and (12).

In the same X-ray generating apparatus, even though objects receive the X-ray energy at the same radiation distance with the same radiation quality (KV) and the same radiation quantity (mAs value: mA(milli-ampere)×s(second)) in front of a detector, due to the unevenness of the luminance efficiency of phosphor material and the capacity of electric charges, the same analog data (output signal) can not be obtained. This correction is conducted since it is necessary to obtain the same level of X-ray image signal output under the same X-ray generating apparatus with the same radiation quality and the same radiation quantity. A gain correction is to adjust the slope of conversion efficiency and an offset correction is to adjust the small peace of signal value thereunder. Since all signals after A/D converter are luminance values, a multiplier is used to add offset and an adder is used to adjust gain correction as shown in FIG. 7.

A P-value conversion table generated in advance, and the correction values of gain and offset are provided in the memory prior to reading images. When reading images, as image signals successively flows from an A/D converter to a buffer, CPU corrects the unevenness of images and the sensitivity of a detector for X-rays by performing offset correction processing (multiplications of correction values) and a gain correction processing (an addition of correction values). After that, corrected image data described above is converted to P-value via a P-value conversion table. The image data converted to P-value is stored in memory and sent to console personal computers as X-ray image signals through a LAN (Local Area Network) controller.

In the above example, 16 bit (0-65535) digital signals are successively processed by using LUT provided in advance for P-value conversion in the memory based on formulas (6) and (12). In this example, a network is used to send X-ray values, however general interfaces such IEEE 1394 and/or USB 2.0 and/or IEEE 802, 11a, 11b and 11g, etc. can be used as the network or LAN.

Further, when converting to P-values, CPU may conduct a gradation processing and/or an edge processing.

### EXAMPLE 2 OF SIGNAL PROCESSING

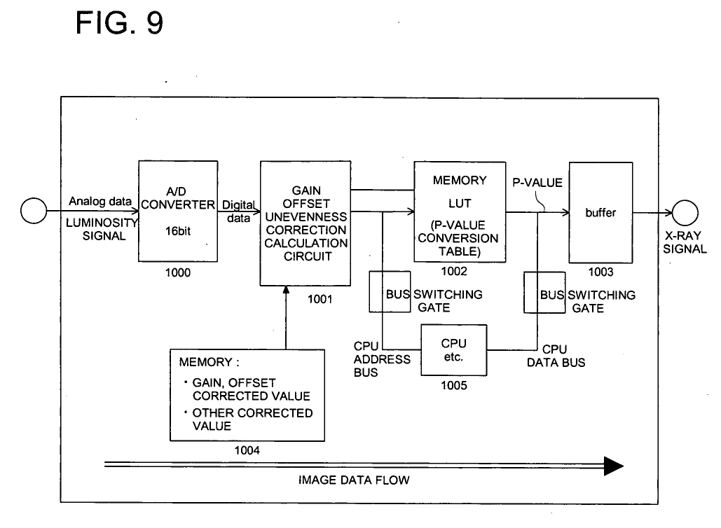

FIG. 9 shows a circuit diagram for conducting a P-vale conversion without having a software method controlled by CPU. Analog signals are converted to digital signals in A/D converter 1000 and addition computations and a multiplications for the corrections of converted signals are successively conducted in gain-offset unevenness correction calculation circuit 1001 while taking the necessary correction data of gain and offset into gain offset unevenness correction calculation circuit 1001. After a correction processing, image data flows into memory 1002. Memory 1002 stores a LUT (Look Up Table) including P-values calculated in advance by formulas (6) and (12) corresponding to 16 bit signal values (0-65535). Image data flows into (16 bit) address bus of memory 1002 and output data converted to P-value is outputted from data bus of memory 1002. X-ray signal value converted to P-value is sent to a display apparatus such as a console personal computer, etc. In this example, buffer 1003 is provided, however various interface circuits can replace it if necessary.

In this example, CPU 1005 is provided so as to rewrite P-value conversion table. However, when a P-value conversion table is not necessary to be rewritten, a non-volatile ROM (Read Only Memory) can replace CPU 1005.

In this example, a gradation processing circuit or a gradation processing CPU can be provided before a P-value conversion tale so as to apply necessary process before outputting a P-value.

As described above, it becomes possible to provide a radiation image detecting-processing apparatus and a radiation image photographing system featuring a high speed processing without having rounding errors caused in plural calculation processes or decreasing accuracy by directly obtaining P-values after a conducting A/D conversion of linear data without converting to density value “D”.

It become possible to widely apply the present invention to a radiation image detecting-processing apparatus and a radiation image photographing system which can obtain radiation images suitable for medical diagnosis.

1. A radiation image detecting processing apparatus for outputting an output signal to an output device comprising:
a radiation image detecting device for receiving a radiation image on plural detecting elements arranged in a two dimensional layout, generating and outputting an image signal based on the radiation image; and
a first conversion device for converting an image signal outputted from the radiation image detecting device into an output signal being a value linear to a visual sense which is independent from the output device.

2. A radiation image system including a personal computer, a printing device, a data storage device or a display device communicated with the radiation image detecting processing apparatus of claim 1.

3. A radiation image detecting processing apparatus for outputting an output signal to an output device comprising:
a radiation image detecting device for receiving a radiation image on plural detecting elements arranged in a two dimensional layout, generating and outputting an image signal based on the radiation image; and
an image processing device for processing an image signal outputted from the radiation image detecting device,
wherein the image processing device includes a second conversion device for converting an image signal, which is in proportion to a quantity of radiation irradiated to the radiation image detecting device into an output signal being linear to a visual sense which is independent from the output device.

4. A radiation image system including a personal computer, a printing device, a data storage device or a display device communicated with the radiation image detecting processing apparatus of claim 3.

5. The radiation image detecting processing apparatus of claim 1, wherein
the first conversion device includes a first conversion section for setting a luminance difference corresponding to a density difference recognized by an average human being observer by using a grayscale standard display function curve as the value being linear to a visual sense.

6. A radiation image system including a personal computer, a printing device, a data storage device or a display device communicated with the radiation image detecting processing apparatus of claim 5.

7. The radiation image detecting processing apparatus of claim 3, further comprising:
a normalizing processing device for converting the image signal to a normalized image signal of being in proportion to a quantity of radiation irradiated to the radiation image detecting device or a logarithmic value of a quantity of radiation which includes a predetermined signal value; and
a processing device for setting an luminance difference of the normalized image signal from the normalizing processing device or at least an image signal to which a gradation process for converting gradation is applied, which corresponding to a density difference of which an average human can recognizes, wherein
either the first conversion device or the first conversion device including the first conversion section and the second conversion device are arbitrarily combined so that deterioration of accuracy of image data from the radiation image detecting device and/or process errors caused by a calculation are decreased.

8. A radiation image system including a personal computer, a printing device, a data storage device or a display device communicated with the radiation image detecting processing apparatus of claim 7.

9. The radiation image detecting processing apparatus of claim 1, wherein
the first conversion device includes a second conversion section for setting a luminance difference as a P-value corresponding to a density difference recognized by an average human being by using a grayscale standard display function curve as a value being linear to a visual sense.

10. A radiation image system including a personal computer, a printing device, a data storage device or a display device communicated with the radiation image detecting processing apparatus of claim 9.

11. The radiation image detecting processing apparatus of claim 1, wherein
the first converting device includes a third conversion section for converting the image signal into an output signal being a luminous value of which average observer can recognize under a certain observation condition.

12. A radiation image system including a personal computer, a printing device, a data storage device or a display device communicated with the radiation image detecting processing apparatus of claim 11.

13. The radiation image detecting processing apparatus of claim 1, wherein
the radiation image detecting device outputs a 14 bit or 16 bit image signal.

14. A radiation image system including a personal computer, a printing device, a data storage device or a display device communicated with the radiation image detecting processing apparatus of claim 13.

15. The radiation image detecting processing apparatus of claim 1, wherein
the radiation image detecting device outputs a 14 bit or 16 bit image signal, and
the radiation image detecting device utilizes a grayscale standard display function curve for setting a luminance difference corresponding to a density difference of which an average human being observer can recognize to convert the radiation image information.

16. A radiation image system including a personal computer, a printing device, a data storage device or a display device communicated with the radiation image detecting processing apparatus of claim 15.
